(19) United States
(12) Patent Application Publication
(10) Pub. No.: US 2009/0128706 A1
(43) Pub. Date: May 21, 2009

(54) VIDEO SIGNAL OUTPUT CIRCUIT AND SEMICONDUCTOR INTEGRATED CIRCUIT INCLUDING THE SAME

(75) Inventors: Toshinobu Nagasawa, Osaka (JP); Tetsushi Toyooka, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 12/096,533

(22) PCT Filed: Dec. 5, 2007
(86) PCT No.: PCT/JP2007/073459

§ 371 Date: Jun. 6, 2008

(30) Foreign Application Priority Data
Dec. 8, 2006 (JP) 2006-332293

(51) Int. Cl. H04N 5/18; H04N 5/14; H04N 5/63

(52) U.S. Cl. 348/689; 348/707; 348/730; 348/E05.071; 348/E05.062; 348/E05.127

(57) ABSTRACT

A video output circuit that is operated at a low power supply voltage and capable of achieving reduced power consumption with a simple circuit configuration and a semiconductor integrated circuit incorporating the same are provided. The video signal output circuit includes a video signal input terminal 1, a clamp circuit 3 that is connected to the video signal input terminal 1, a voltage-current conversion circuit 4 that is connected to the clamp circuit 3, a current amplifier circuit 5 that is connected to the voltage-current conversion circuit 4 and a video signal output terminal 6 that is connected to the current amplifier circuit 5, wherein a resistor 8 is connected between the video signal output terminal 6 and a ground, a transmission line 9 is connected with the video signal output terminal 6, and a load resistor 10 having an equal resistance to the resistor 8 is connected between another end of the transmission line 9 and a ground. The clamp circuit 3 fixes a negative signal voltage.

### TECHNICAL FIELD

The present invention relates to a video signal output circuit to be incorporated into a semiconductor integrated circuit. In particular, the present invention relates to a video signal output circuit that outputs a video signal as a current output, thereby achieving a lower power supply voltage so as to reduce power consumption, and a semiconductor integrated circuit including the same.

### BACKGROUND ART

In recent years, accompanying the ever-lower power consumption and the reduction of a withstand voltage of a gate oxide film caused by the use of a fine gate length process, the power supply voltage of a digital signal processing circuit portion has become lower. An analog signal processing circuit portion also has been desired to be operated at the same power supply voltage as the digital signal processing portion, and there have been demands for lower power supply voltage and lower power consumption in a semiconductor integrated circuit including a video signal output circuit, which is a driving circuit of a video line output.

In the following, a conventional video signal output circuit will be described.

FIG. 11 illustrates an exemplary configuration of a most general video signal output circuit. As shown in FIG. 11, the conventional video signal output circuit is constituted by connecting a video signal input terminal 51 with a coupling capacitor 52, a voltage amplifier circuit 53 and a video signal output terminal 54 in this order. The video signal output terminal 54 is connected in series with a resistor 55 and a coaxial cable 56 serving as a transmission line, and a load resistor 57 is connected between the other end of the coaxial cable 56 and a ground.

In the video signal output circuit with the above-described configuration, an input signal whose bias component has been cut by the coupling capacitor 52 is amplified in the voltage amplifier circuit 53 having a low output impedance and outputted from the video signal output terminal 54. In a transmission system of the outputted video signal, the resistor 55 is placed in series with the output terminal 54, and the load resistor 57 is connected between the other end of the coaxial cable 56 and the ground in order to reduce the influence of reflection in a transmission path, so that impedances at both ends of the coaxial cable 56 are matched. In the field of video signals, the resistor 55 and the load resistor 57 usually are set to 75Ω.

FIG. 12 shows the width of voltages as an output swing amount of the video signal outputted from the conventional video signal output circuit illustrated in FIG. 11. As shown in FIG. 12, the swing amount at point V02 in FIG. 11 needs to be about +1 V when the video signal is 0 V on average. Thus, the output swing amount at point V01, which is the output terminal of the video signal, is ±2 V. At this time, a positive power supply voltage VDD needs to be equal to or higher than +2.0 V, and a negative power supply voltage VSS needs to be equal to or lower than −2.0 V.

Now, as another example of the conventional video signal output circuit, that of a current output type will be described. The video signal output circuit of the current output type illustrated in FIG. 13 is constituted by connecting a video input terminal 61 with a coupling capacitor 62, a voltage-current (V/I) conversion circuit 63, a current amplifier circuit 64 and a video signal output terminal 65 in this order. A resistor 66 is connected between the video signal output terminal 65 and a ground. Further, a coaxial cable 67 serving as a transmission line is connected, and a load resistor 68 is connected between the other end of the coaxial cable 67 and a ground.

In the video signal output circuit with the above-described configuration, an input signal whose bias component has been cut by the coupling capacitor 62 is subjected to a voltage-current conversion in the V/I conversion circuit 63 and further amplified in the current amplifier circuit 64 having a high output impedance, and then a video signal is outputted as a current signal. The resistor 66 is placed between the video signal output terminal 65 and the ground, and the load resistor 68 is provided between the other end of the coaxial cable 67 and the ground in order to match impedances at both ends of the coaxial cable 67. Here, both of the resistor 66 and the load resistor 68 also are 75Ω. As in FIG. 14 where the swing amount of the output signal is shown, the swing amount at point V04 needs to be about ±1 V when the video signal is 0 V on average. As being of the current output type, the output swing amount at point V03 also is ±1 V. At this time, a positive power supply voltage VDD needs to be equal to or higher than 1.0 V, and a negative power supply voltage VSS needs to be equal to or lower than −1.0 V.

As becomes clear from the comparison between the output swing amounts in FIGS. 12 and 14, the video signal output circuit of the current output type illustrated in FIG. 14 is more advantageous in achieving a lower power supply voltage.

FIG. 15 illustrates an exemplary configuration of the current amplifier circuit 64 used in the video signal output circuit of the current output type shown in FIG. 13.

In FIG. 15, numerals 71 and 72 denote transistors, numerals 73 and 74 denote current sources, and all of them constitute a current mirror circuit. The relationship between an aspect ratio of the transistor 71 and that of the transistor 72 is set to 1:N, and the current ratio between the current source 73 and the current source 74 also is set to 1:N, thereby making it possible to constitute a current amplifier circuit with an N-fold current gain. Incidentally, in order to secure the ±1.0 V of output signal swing amount in the video signal output terminal 65 as in the case of the video signal output circuit shown in FIG. 13, since two resistors of 75Ω are connected in parallel,

1 (V)/(75/2(Ω))=0.0267 (A),

so that about 27 mA is needed as the current amount of the N-side current source 74. For example, when the both end voltage at which the current source 74 can maintain its capacity is 0.2 V, the value of VSS is

(−1.0 V)+(−0.2 V),

resulting in −1.2 V, and the electric power consumed when the negative side voltage, i.e., the voltage at V03 is −1 V is

27 (mA)×1.2 (V)=32.4 (mW),

resulting in 32.4 mW.

Patent document 1 describes a technology of using two transistors and two operational transconductance amplifiers that constitute a current mirror in order to prevent the waste of voltage or current caused by the resistor that is connected in series or in parallel with the output terminal in the conventional video signal output circuit described above.

Patent document 1: JP 2000-511023 A

### DISCLOSURE OF INVENTION

### Problem to be Solved by the Invention

However, the above-described conventional video signal output circuit having the configuration illustrated in FIG. 11 is not suitable for achieving a lower power supply voltage because at least 2 V of the power supply voltage is needed for each of the positive and negative sides, and that having the configuration illustrated in FIG. 13 has a problem in that a large current of 27 mA is needed as an idling current for obtaining ±1 V signal swing, resulting in a high power consumption.

Furthermore, the configuration described in Patent document 1 provides a feedback circuit in the video output circuit so as to achieve equal terminating resistances at both ends of the coaxial cable. In order to match the terminating resistances in the entire video signal band, it is necessary to use a high-cost fine process rule with good frequency characteristics in the feedback circuit. Also, it is conceivable that the presence of a feedback loop in the output portion may increase the risk of oscillation, etc.

Moreover, in the case where a negative power supply is realized with a charge pump circuit as a built-in power supply, a large current flowing in this negative power supply VSS requires the built-in power supply to have a high power supply capacity. This causes the problems of increasing transistor size and chip area and further enhances the risk that a switching noise in the charge pump circuit may influence the video signal.

Accordingly, the object of the present invention is to provide a video output circuit capable of achieving a lower power consumption with a simple circuit configuration, and a semiconductor integrated circuit incorporating the same.

### Means for Solving Problem

In order to solve the problems described above, a video signal output circuit according to the present invention includes a video signal input terminal, a clamp circuit that is connected to the video signal input terminal, a voltage-current conversion circuit that is connected to the clamp circuit, a current amplifier circuit that is connected to the voltage-current conversion circuit, and a video signal output terminal that is connected to the current amplifier circuit. A resistor is connected between the video signal output terminal and a ground, a transmission line is connected with the video signal output terminal, and a load resistor having an equal resistance to the resistor is connected between another end of the transmission line and a ground. The clamp circuit fixes a negative signal voltage.

Further, a video signal output circuit according to the present invention includes a system outputting a luminance signal including a luminance signal input terminal, a clamp circuit that is connected to the luminance signal input terminal, a luminance signal voltage-current conversion circuit that is connected to the clamp circuit, a luminance signal current amplifier circuit that is connected to the luminance signal voltage-current conversion circuit, and a luminance signal output terminal that is connected to the luminance signal current amplifier circuit, and a system outputting a color signal including a color signal input terminal, a color signal voltage-current conversion circuit that is connected to the color signal input terminal, a color signal current amplifier circuit that is connected to the color signal voltage-current conversion circuit, and a color signal output terminal that is connected to the color signal current amplifier circuit. The luminance signal output terminal that is connected with the color signal output terminal via a capacitor serves as a video signal output terminal. The clamp circuit fixes a negative signal voltage.

### EFFECTS OF THE INVENTION

With the above configuration, in the video signal amplifier circuit according to the present invention, the negative power supply voltage can be lowered by the clamp circuit. Thus, it is possible to achieve a video signal output circuit with a low power supply voltage and also a reduced power consumption, and a semiconductor integrated circuit including the same.

### BRIEF DESCRIPTION OF DRAWINGS

FIG. 1 illustrates a circuit configuration of a video output circuit according to Embodiment 1 of the present invention.

FIG. 2 shows waveforms at individual points in the video output circuit according to Embodiment 1 of the present invention.

FIG. 3 shows output voltage swing amounts in the video output circuit according to Embodiment 1 of the present invention.

FIG. 4 illustrates a circuit configuration of a video output circuit according to Embodiment 2 of the present invention.

FIG. 5 shows waveforms at individual points in the video output circuit according to Embodiment 2 of the present invention.

FIG. 6 shows waveforms at individual points in the video output circuit according to Embodiment 2 of the present invention.

FIG. 7 is a circuit diagram showing an exemplary current amplifier circuit used in a system outputting a luminance signal in the video output circuit according to Embodiment 2 of the present invention.

FIG. 8 is a circuit diagram showing an exemplary current amplifier circuit used in a system outputting a color signal in the video output circuit according to Embodiment 2 of the present invention.

FIG. 9 is a circuit diagram showing a configuration of a terminal detection circuit in Embodiments 1 and 2 of the present invention.

FIG. 10 is a drawing comparing waveforms at load and at no load in Embodiments 1 and 2 of the present invention.

FIG. 11 is a circuit diagram showing a configuration of a first conventional video signal output circuit.

FIG. 12 shows output voltage swing amounts in the first conventional video signal output circuit.

FIG. 13 is a circuit diagram showing a configuration of a second conventional video signal output circuit.

FIG. 14 shows output voltage swing amounts in the second conventional video signal output circuit.

FIG. 15 is a circuit diagram showing an exemplary current amplifier circuit used in the second conventional video signal output circuit.

### EXPLANATION OF LETTERS OR NUMERALS

1 Video input terminal
2 Input capacitor
3 Clamp circuit
4 Voltage-current (V/I) conversion circuit
5 Current amplifier circuit
6 Video signal output terminal
7 Terminal detection circuit
8 Resistor
9 Coaxial cable
10 Load resistor

### DESCRIPTION OF THE INVENTION

In the above-described video signal output circuit according to the present invention, it is desired that in the system outputting the luminance signal, a synchronization period is detected from the luminance signal, the luminance signal whose synchronous signal is removed is amplified by the luminance signal current amplifier circuit and outputted during a period other than the synchronization period, and a current corresponding to the synchronous signal is outputted during the synchronization period. It also is desired to detect the synchronization period from the luminance signal in a sync separation circuit, and clamp the luminance signal in a pedestal clamp circuit by an output of the sync separation circuit, followed by removing the synchronous signal from the luminance signal. This makes it possible to lower the negative power supply voltage further.

Moreover, it is preferable to include a terminal detection circuit that measures a lowest potential at load and a lowest potential at no load from an output signal waveform of the video signal output terminal, sets a reference potential between the lowest potential at load and the lowest potential at no load, thereby detecting whether or not a load is connected to the video output terminal. In this manner, the load can be detected by utilizing the fact that, due to the current output of the video signal, the amplitude increases when the load is detached.

Further, a semiconductor integrated circuit according to the present invention includes any of the above-described video signal output circuits according to the present invention.

The following is a description of embodiments of the present invention, with reference to the accompanying drawings.

### Embodiment 1

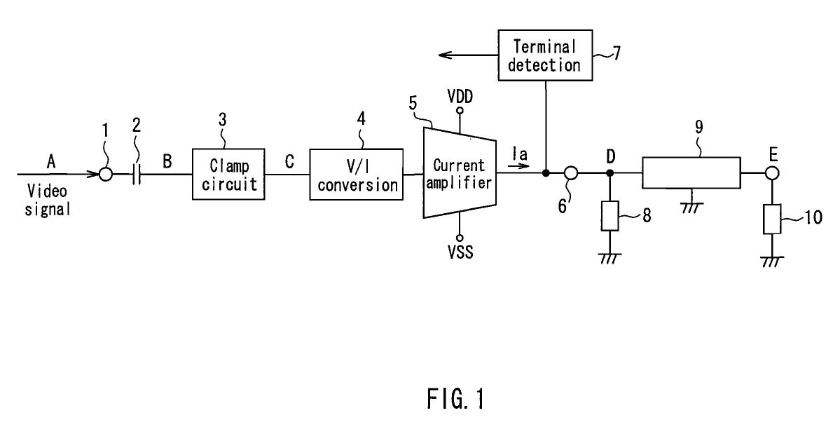

FIG. 1 illustrates a circuit configuration of a video output circuit according to Embodiment 1 of the present invention.

As shown in FIG. 1, in the video output circuit according to the present embodiment, a video signal input terminal 1 is connected with an input capacitor 2 and then with a clamp circuit 3, a voltage-current (V/I) conversion circuit 4, a current amplifier circuit 5 and a video signal output terminal 6 in this order. Here, the video signal output circuit according to the present embodiment is different from the conventional video signal output circuit illustrated in FIG. 13 in that the clamp circuit 3 is provided. The V/I conversion circuit 4 and the current amplifier circuit 5 may be the same as the conventional V/I conversion circuit 63 and the conventional current amplifier circuit 64 shown in FIG. 13.

A resistor 8 is connected between the video signal output terminal 6 and a ground. Also, a coaxial cable 9 serving as a transmission line is connected. Then, in order to match impedances at both ends of the coaxial cable 9, a load resistor 10 having an equal resistance to the resistor 8 is connected between the other end of the coaxial cable 9, which is different from the end to be connected to the video signal output terminal 6, and a ground. In the field of video signals, their resistances usually are 75Ω.

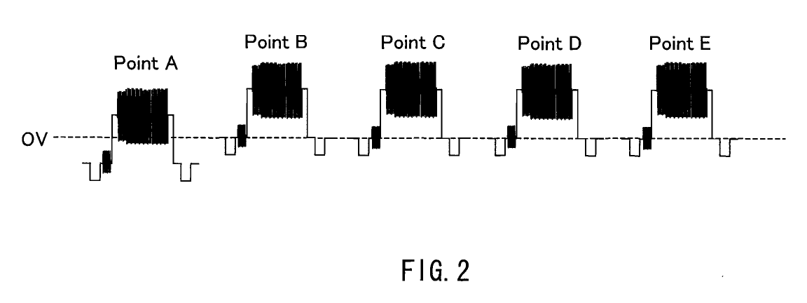

The signal processing in the video signal output circuit with the above-described configuration according to Embodiment 1 of the present invention will be described with reference to FIG. 1 and FIG. 2, which shows signal waveforms at individual points indicated in FIG. 1.

In FIG. 1, when the clamp circuit 3 is a clamp circuit that fixes the lowest potential to a constant voltage, for example, a video signal inputted in the video signal input terminal 1 (at point A) is subjected to a clamping operation of the clamp circuit 3, so that the lowest potential of the video signal at point B is fixed to a negative constant voltage. The constant voltage at this time, for example, is −0.286 V in the case of the NTSC system and −0.3 V in the case of the PAL system as indicated by B in FIG. 2 so that a synchronous signal component of the video signal is a negative amplitude voltage. Incidentally, a potential (position) at the border between the luminance signal and the synchronous signal, which is set to 0 V here, is referred to as a pedestal position.

This signal waveform at point B is transmitted to point C, and converted into a current signal in the V/I conversion circuit 5. Then, its inverted output is amplified in the current amplifier circuit 5. The inverted output of the current amplifier circuit 5 is made to flow into a circuit load that is connected to the video signal output terminal 6 and constituted by the resistor 8, the coaxial cable 9 and the load resistor 10, so that the video signals at both ends D and E of the coaxial cable 9 are desired signals. Accordingly, all of the signal waveforms at points B, C, D and E are the same as shown in FIG. 2.

Incidentally, the terminal detection circuit 7 is connected to the video signal output terminal 6 and judges whether the load resistor 10 is connected to the ground and terminated or it is open. The details will be described later.

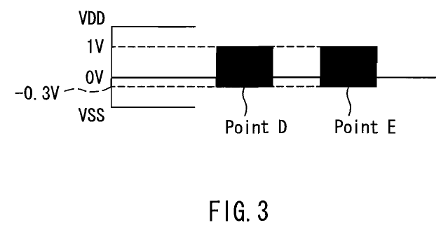

FIG. 3 shows swing amounts of the output signals at point D and point E in the video signal output circuit according to the present embodiment shown in FIG. 1. In the present embodiment, the clamp circuit 3 fixes the value of the maximum signal voltage on the negative side to −0.3 V in the case of the PAL system as described above. Therefore, as becomes clear from FIG. 3, the amplitude of the output signal on the negative side is suppressed within −0.3 V, thus making it possible to suppress the required VSS power supply voltage on the negative side to a low level. As a result, the power consumption of the video signal output circuit can be suppressed.

For example, when the height (absolute value) of the synchronous signal is set to 0.3 V, a current amount necessary for the current source connected to the output terminal is 8 mA from

0.3 (V)/(75/2 (Ω))=0.008 (A).

Assuming that 0.2 V is needed for the voltage at both ends of this current source, VSS is

(−0.3 V)+(−0.2 V),

resulting in −0.5 V.

Thus, the electric power consumed on the negative side is

8 (mA)×0.5 (V)=4.0 (mW),

resulting in 4.0 mW. When this value is compared with 32.4 mW in the conventional circuit, considerable reduction of the overall power consumption has been achieved.

Although Embodiment 1 described above has set the clamp voltage of the clamp circuit 3 to −0.286 V for the NTSC system and −0.3 V for the PAL system as an example, the present invention is not limited to this. The clamp voltage may be set suitably according to the power consumption and the average DC specification of the output signal. For example, in the case of a color bar, which is a typical video signal, the clamp voltage is set so that the average DC value of its output signal is 0 V.

### Embodiment 2

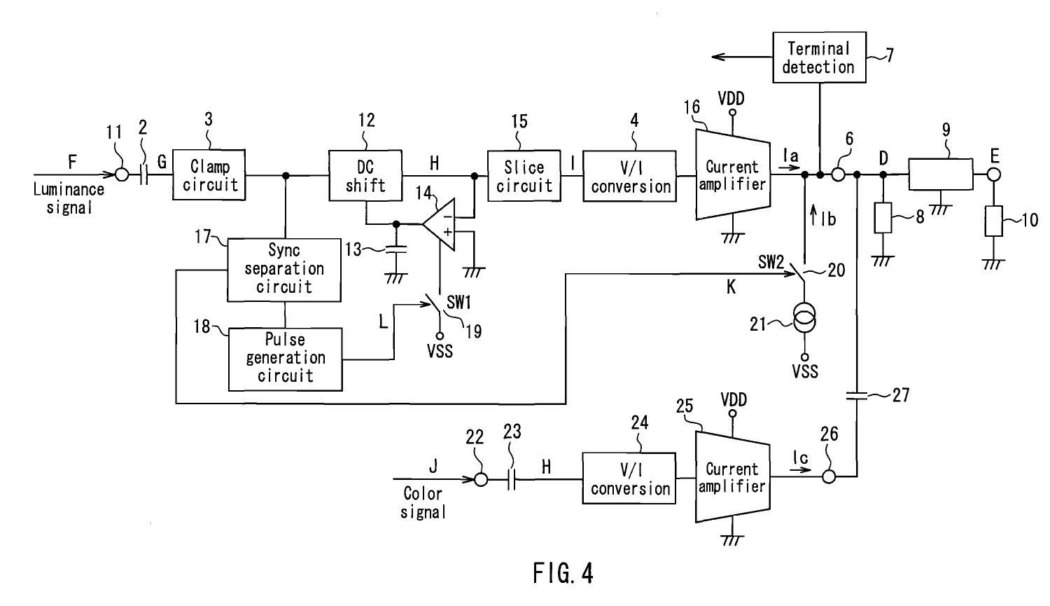

Next, Embodiment 2 of the video signal output circuit according to the present invention will be described referring to FIG. 4, which shows its circuit configuration.

The video signal output circuit according to Embodiment 2 of the present invention shown in FIG. 4 performs a so-called Y/C separation in which a video signal is inputted in the state of being divided into a luminance signal and a color signal, and these signals are amplified separately and then synthesized so as to be outputted as a video signal. The video signal output circuit includes two systems, i.e. a system outputting the luminance signal and a system outputting the color signal.

Among them, in the system outputting the luminance signal, the clamp circuit 3 is connected via the input capacitor 2 connected to a luminance signal input terminal 11, and an output of the clamp circuit 3 is converted into a current in the voltage-current (V/I) conversion circuit 4. Then, its inverted output is amplified in a current amplifier circuit 16. Further, its inverted output is outputted to the video signal output terminal 6, which also serves as a luminance signal output terminal. As described above, a basic flow in the processing of the luminance signal is the same as that shown in FIG. 1 as the video signal amplifier circuit in Embodiment 1 described above. Therefore, these common portions can have the circuit configuration shown in FIG. 1. Like numerals in FIGS. 1 and 4 indicate the same components.

Compared with the circuit configuration shown in FIG. 1, the video signal output circuit according to the present embodiment has a circuit configuration achieving further reduction of the power consumption, which will be described in the following.

In the video signal output circuit in the present embodiment, in order to separate a synchronous signal at the later stage, the luminance signal first is clamped to a desired clamp voltage V_{CLAMP} in the clamp circuit 3 connected to the input capacitor 2. Also, as shown in FIG. 4, an output end of this clamp circuit 3 is connected with a DC shift circuit 12, a DC shift capacitor 13, an OP amplifier 14 and a slice circuit 15 in this order. Further, an output from the clamp circuit 3 is inputted to a sync separation circuit 17, and an output of this sync separation circuit 17 supplies a switching signal to a first switch (SW1) 19 for driving the OP amplifier 14 via a pulse generation circuit 18 that generates a clamp pulse.

Further, the sync separation circuit 17 also supplies a switching signal to a second switch (SW2) 20 for switching a current of a constant current source 21 to be outputted to the video signal output terminal 6. More specifically, for example, during a period in which the clamp pulse, which is the output of the pulse generation circuit 18, is at Hi level, the SW1 is turned ON so that the OP amplifier 14 is operated. Also, for example, during a period in which the output of the sync separation circuit 17 is at Hi level, the SW2 is turned ON

Now, the system outputting the color signal is constituted by connecting an input capacitor 23 for a color signal connected to a color signal input terminal 22 with a voltage-current (V/I) conversion circuit 24, a current amplifier circuit 25 and a color signal output terminal 26 in this order. The color signal output terminal 26 is connected to the video signal output terminal 6, which also serves as the luminance signal output terminal, via a capacitor 27 for color signal superposition.

Similarly to Embodiment 1 described above, the resistor 8 is connected between the video signal output terminal 6 and a ground. Also, the coaxial cable 9 serving as a transmission line is connected. Then, in order to match impedances at both ends of the coaxial cable 9, the load resistor 10 having an equal resistance to the resistor 8 is connected between the other end of the coaxial cable 9 and a ground. In the present embodiment, the resistor 8 and the load resistor 10 also have a resistance of 75Ω.

The signal processing in the video signal output circuit with the above-described configuration according to Embodiment 2 of the present invention will be described with reference to FIG. 4 and FIGS. 5 and 6, which show signal waveforms at individual points indicated in FIG. 4.

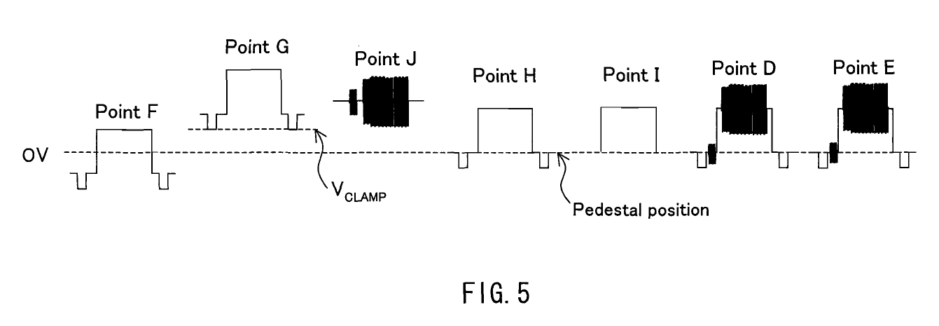

As illustrated by the waveforms in FIG. 5, the luminance signal inputted from the luminance signal input terminal 11 (at point F) is inputted via the input capacitor 2 to the clamp circuit 3. As described above, the luminance signal in the present embodiment is clamped to a desired clamp voltage V_{CLAMP} at point G and inputted to the DC shift circuit 12. Then, the luminance signal is clamped to the pedestal clamp position by a pedestal clamp circuit constituted by the DC shift circuit 12, the OP amplifier 14 and the DC shift capacitor 13. More specifically, during a period that is not a synchronization period in which a clamp pulse generated by the sync separation circuit 17 and the pulse generation circuit 18 is at Hi level, namely, during a period in which luminance information contained in the luminance signal is outputted, the SW1 is turned ON so that the OP amplifier 14 is operated. Consequently, a feedback loop for biasing the capacitor 13 functions so that the pedestal position is 0 V, thus carrying out the pedestal clamp. FIG. 5 shows the waveform at point H at this time.

The luminance signal that has been subjected to the pedestal clamp is inputted to the slice circuit 15 for slicing off the waveform equal to or lower than 0 V, and a luminance voltage signal equal to or higher than 0 V is outputted as a signal that is obtained by removing the synchronous signal from the luminance signal and has a waveform at point I. This signal is subjected to current conversion by the V/I conversion circuit 4, and the inverted output of the V/I conversion circuit 4 is inputted to the current amplifier circuit 16. Furthermore, the current amplification is carried out in the current amplifier circuit 16, and the inverted output is outputted from the video signal output terminal 6 to the resistor 8, the coaxial cable 9 and a load formed of the load resistor 10 as the luminance signal of a current Ia.

On the other hand, during a synchronization period in which not the luminance information but the synchronous signal in the luminance signal is outputted, the pulse generated by the sync separation circuit 17 is at Hi level, so that the SW2 is turned ON. Then, during this synchronization period, a current Ib from the current source 21 for generating a synchronous current corresponding to the height of the synchronous signal is outputted from the video signal output terminal 6 to the resistor 8, the coaxial cable 9 and the load formed of the load resistor 10 as a synchronous signal portion in the luminance signal.

In the system outputting the color signal, the color signal inputted from the color signal input terminal 22 (at point J) is inputted via the input capacitor 23 to the voltage-current (V/I) conversion circuit 24 and subjected to current conversion, and an inverted output of the V/I conversion circuit 24 is inputted to the current amplifier circuit 25 for color signal. Then, the current amplification is carried out by the current amplifier circuit 25, and its inverted output is outputted to the color signal output terminal 26. This color signal output terminal 26 is connected to the video signal output terminal 6 via the capacitor 27 for color signal superposition, and a current Ic, which is the color signal, is synthesized with the luminance signal (Ia+Ib) so as to be a video output signal.

As shown in FIG. 5, a signal waveform of the video output signal synthesized in the video signal output terminal 6 (at point D) and a signal waveform at point E where this video output signal is transmitted are the same as the output signal waveforms of the video signal output circuit illustrated in Embodiment 1.

As described above, in the video signal output circuit according to the present embodiment, three signal currents Ia, Ib and Ic are combined to obtain a desired video output signal.

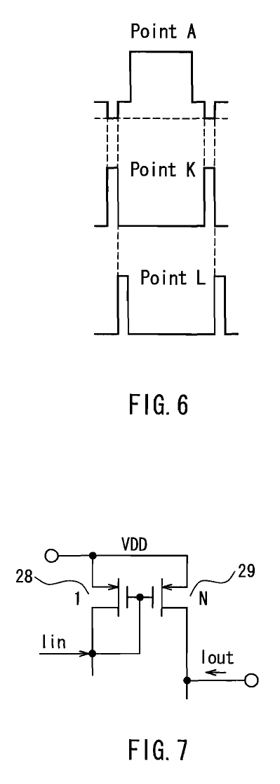

FIG. 6 shows control signal waveforms of the SW1 and the SW2 in the video signal output circuit in the present embodiment. The inputted luminance signal at point A shown in FIG. 6 is clamped to a desired clamp voltage V_{CLAMP} in the clamp circuit 3, inputted to the sync separation circuit 17, in which only the synchronous signal is separated, and inputted to the SW2 as a pulse waveform at point K that is at Hi level in the synchronization period. Also, the output of the sync separation circuit 17 is inputted to the pulse generation circuit 18 and supplies to the SW1 a clamp pulse that is at Hi level for a certain duration after the synchronization period, for example, from 1 μs to 4 μs (at point L). In this manner, the luminance signal can be separated into the synchronous signal during the synchronization period and the signal that is obtained by removing the synchronous signal, namely, the signal containing substantially only the luminance information, during the period other than the synchronization period.

The terminal detection circuit 7 is connected to the video signal output terminal 6 and judges whether the load resistor 10 is terminated to the ground or it is open. The details will be described later.

As described above, in the video signal output circuit illustrated in Embodiment 2 of the present invention, the amplitude on the negative side also can be suppressed similarly to the video signal output circuit illustrated as Embodiment 1. Accordingly, it is possible to suppress the negative power supply voltage VSS to a low level, thereby suppressing the power consumption. The voltage swing amount is as shown in FIG. 3, similarly to that in Embodiment 1 of the present invention.

Further, in the video signal output circuit according to Embodiment 2 of the present invention, by limiting the current so as to flow into the negative power supply voltage VSS only during the synchronization period, it is possible to reduce the idling current passed constantly through the VSS, so that the power consumption generated by the negative power supply can be suppressed in an efficient manner. Incidentally, in the configuration of the video signal output circuit in Embodiment 2, since the current amplifier circuit 26 for the color signal is needed in addition to that for the luminance signal, the power consumption of the entire circuit is higher compared with the video signal output circuit that outputs the video signal without any separation as shown in FIG. 1 as Embodiment 1, for example. However, the current output during the synchronization period is supplied separately from the current source as in the circuit configuration shown in FIG. 4, thereby making it possible to obtain the video output circuit that has the same level of power consumption as that in the case shown in FIG. 1 where the video signal is not divided into the luminance signal and the color signal.

Moreover, by employing the circuit configuration of the present embodiment shown in FIG. 4, a built-in charge pump circuit can be used as the negative power supply. Therefore, the current does not flow into the negative power supply during a period other than the synchronization period, so that it is possible to suppress switching noise caused by the charge and discharge of the charge pump circuit during the period other than the synchronization period. This also produces an effect of suppressing the influence of the switching noise on the video signal to be outputted.

FIG. 7 is a circuit diagram showing an example of the current amplifier circuit 16 used in the system outputting the luminance signal shown in FIG. 4. In FIG. 7, numerals 28 and 29 both denote PMOS transistors. The PMOS transistors 28 and 29 constitute a current mirror. The relationship between an aspect ratio of the transistor 28 and that of the transistor 29 is set to 1: N, thereby making it possible to constitute a current amplifier with an N-fold current gain. Incidentally, in the present embodiment, since only the signal equal to or higher than 0 V is subjected to the current conversion due to the slice circuit 15, there is no need to provide the constant current sources 73 and 74 used in the current amplifier circuit 64 in the conventional video output circuit illustrated in FIG. 15.

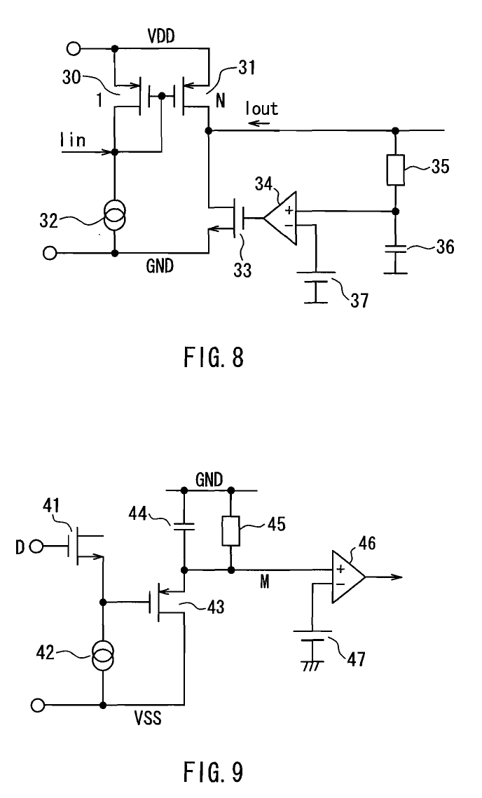

FIG. 8 shows a circuit configuration of an example of the current amplifier circuit 25 used in the system outputting the color signal in the present embodiment. In FIG. 8, numerals 30 and 31 denote PMOS transistors, numeral 32 denotes a current source, numeral 33 denotes an NMOS transistor, numeral 34 denotes an OP amplifier, numeral 35 denotes a resistor, numeral 36 denotes a capacitor, and numeral 37 denotes a reference voltage. The resistor 35 and the capacitor 36 are circuits that constitute a low-pass filter so as to cut the color signal and obtain a direct current component of a drain voltage of the PMOS transistor 31. Further, the direct current component of the drain voltage of the PMOS transistor 31 and the reference voltage 37 are inputted to a positive input and a negative input of the OP amplifier 34, respectively, and the output of the OP amplifier 34 is inputted to a gate of the NMOS transistor 33, thereby configuring a feedback loop that stabilizes a direct current voltage of a drain terminal of the PMOS transistor 31 to the reference voltage 37. The PMOS transistors 30 and 31 constitute a current mirror. The relationship between an aspect ratio of the transistor 30 and that of the transistor 31 is set to 1: N, thereby making it possible to constitute a current amplifier with an N-fold current gain. Then, in the circuit shown in FIG. 8, since the feedback loop is configured so as to achieve the DC stabilization, the ratio between a drain current of the current source 32 and that of the NMOS transistor 33 also is about 1: N. With the configuration described above, even when the color signal output is coupled to the luminance signal output via the capacitor 27, the DC level of the output of the current amplifier circuit 26 in the system outputting the color signal is stabilized, thus allowing a current output of the color signal.

The following is a detailed description of the terminal detection circuit 7 shown as part of the above-described configuration of the video signal output circuit according to Embodiments 1 and 2 of the present invention.

As in the specific circuit configuration shown in FIG. 9, the terminal detection circuit 7 includes an NMOS transistor 41, a current source 42, a PMOS transistor 43, a peak detection capacitor 44, a high resistor 45 for discharge, a comparator 46 and a reference voltage 47.

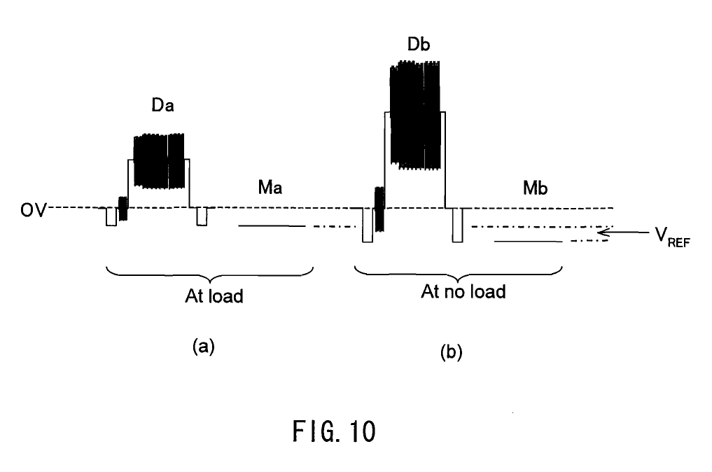

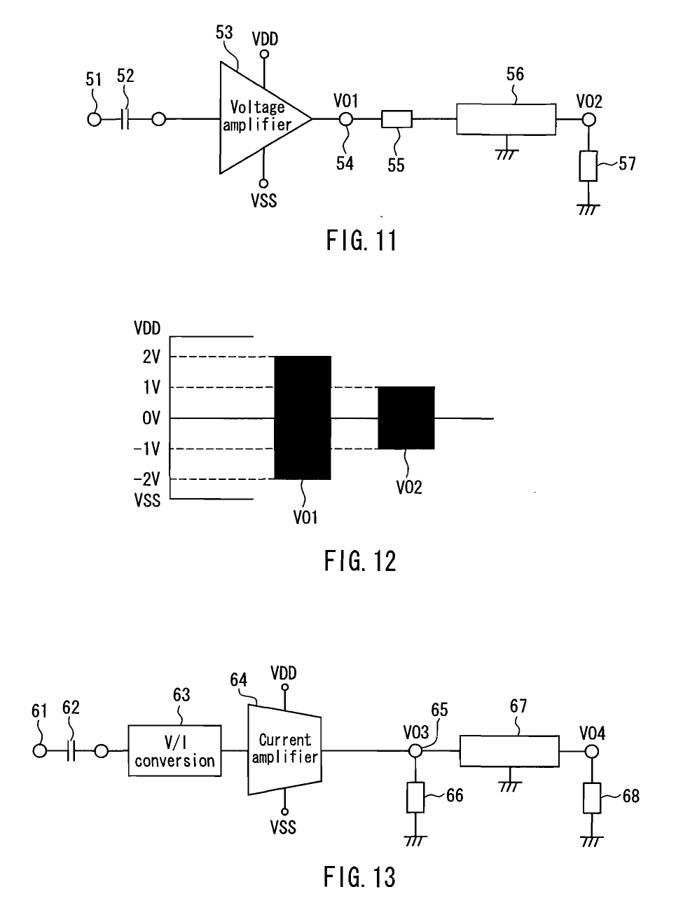

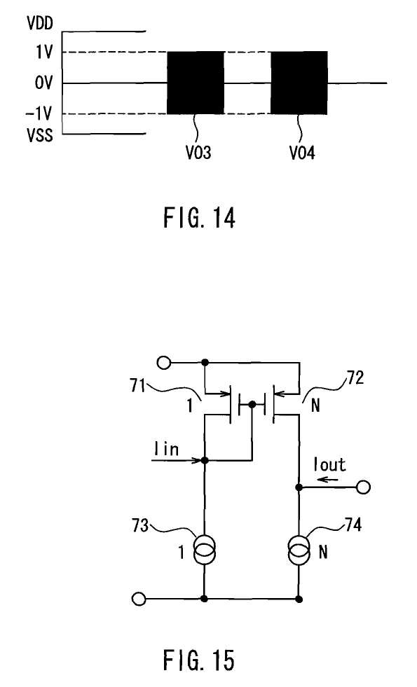

FIG. 10 shows output signal waveforms at point D, which corresponds to the video signal output terminals in FIGS. 1 and 4, and waveforms at point M in FIG. 9 in the case at load where the load resistor 10 is connected to the ground and the case at no load where the load resistor 10 is not connected to the ground but is open in the configuration of the video signal output circuits shown in FIGS. 1 and 4.

At load, the output waveform at point D in FIGS. 1 and 4 is indicated by Da shown in FIG. 10(a). At this time, in the terminal detection circuit shown in FIG. 9, a signal is transmitted to the gate of the PMOS transistor 43 by a source follower constituted by the NMOS transistor 41 and the current source 42, and a lowest potential is retained by a negative peak detection circuit constituted by the PMOS transistor 43, the capacitor 44 and the resistor 45. Here, assuming that the NMOS transistor 41 and the PMOS transistor 43 have equal gate-source voltages during operation, a lowest value of the signal at point D is retained at point M shown in FIG. 9. The potential of the detected lowest value is indicated by Ma in FIG. 10(a). Incidentally, although the retained voltage is discharged gradually by the resistor 45, the lowest value is retained again every time the synchronization period begins.

On the other hand, the amplitude of the video output signal at no load is twice as large as that at load. Therefore, the voltage at point M also is larger on the negative side. FIG. 10(b) shows a waveform Db of the video output signal at point D and a potential Mb at point M in this state at no load. By setting the reference voltage (V_{REF}) 47 to a value between the potential Ma at point M at load and the potential Mb at point M at no load as shown in FIG. 10, it is possible to achieve easily terminal detection of whether or not the load is connected properly to the output terminal in the output of the comparator 46. Accordingly, with the terminal detection circuit illustrated in FIG. 9, when the load is detached during the operation of the video signal output circuit, for example, the video signal output circuit can be put to a power saving mode automatically, thus making it possible to add a load detection function with a simple circuit configuration.

### Embodiment 3

As Embodiment 3 of the present invention, a semiconductor integrated circuit including the video signal output circuit that has been described in Embodiments 1 and 2 above will be described.

The semiconductor integrated circuit according to the present invention is used so as to have a video display function as portable equipment (such as a digital still camera, a digital video camera or a mobile phone), for example, and has the video signal output circuit that has been described in each of the embodiments above. It should be noted that a single semiconductor integrated circuit usually includes an audio signal output circuit that is used together with the video signal output circuit, and a power supply circuit such as a charge pump negative power supply circuit that supplies a predetermined power voltage to the video signal output circuit and the audio signal output circuit. With the above-described video signal output circuit according to Embodiments 1 and 2 of the present invention, such a semiconductor integrated circuit can reduce the power consumption while achieving a low power supply voltage operation over the entire semiconductor integrated circuit.

As described above, the video signal output circuit according to the present invention adds the clamp circuit in the signal output system in the current output type, thereby setting the negative swing amount within a predetermined range, for example, setting it to the height of the synchronous signal and making it constant. This makes it possible to lower the negative power supply voltage VSS, thus reducing the power consumption.

Further, as illustrated in Embodiment 2, in the video signal output circuit that inputs the luminance signal and the color signal separately, and synthesizes them to be outputted as the video signal, with respect to the luminance signal, a source of current that flows into the negative power supply voltage VSS is driven only during the synchronization period, and with respect to the signal portion representing the luminance information, the operation is carried out only between the positive power supply and the ground. In this manner, the power consumed on the side of the negative power supply voltage can be suppressed still more remarkably, thereby making it possible to reduce the power consumption over the entire video signal output circuit or the entire semiconductor integrated circuit including the same.

### INDUSTRIAL APPLICABILITY

As described above, according to the present invention, the video signal output circuit and the semiconductor integrated circuit including the same can be operated with low power consumption.

Thus, it is possible to utilize the video signal output circuit and the semiconductor integrated circuit including the same particularly effectively in portable equipment that pursues lower voltage and lower power consumption.

1. A video signal output circuit comprising:
a video signal input terminal;
a clamp circuit that is connected to the video signal input terminal;
a voltage-current conversion circuit that is connected to the clamp circuit;
a current amplifier circuit that is connected to the voltage-current conversion circuit; and
a video signal output terminal that is connected to the current amplifier circuit;
wherein a resistor is connected between the video signal output terminal and a ground, a transmission line is connected with the video signal output terminal, and a load resistor having an equal resistance to the resistor is connected between another end of the transmission line and a ground, and
the clamp circuit fixes a negative signal voltage.

2. A video signal output circuit comprising:
a system outputting a luminance signal comprising
a luminance signal input terminal,
a clamp circuit that is connected to the luminance signal input terminal,
a luminance signal voltage-current conversion circuit that is connected to the clamp circuit,
a luminance signal current amplifier circuit that is connected to the luminance signal voltage-current conversion circuit, and
a luminance signal output terminal that is connected to the luminance signal current amplifier circuit; and
a system outputting a color signal comprising
a color signal input terminal,
a color signal voltage-current conversion circuit that is connected to the color signal input terminal,
a color signal current amplifier circuit that is connected to the color signal voltage-current conversion circuit, and
a color signal output terminal that is connected to the color signal current amplifier circuit;
wherein the luminance signal output terminal that is connected with the color signal output terminal via a capacitor serves as a video signal output terminal, and
the clamp circuit fixes a negative signal voltage.

3. The video signal output circuit according to claim 2, wherein in the system outputting the luminance signal, a synchronization period is detected from the luminance signal, the luminance signal whose synchronous signal is removed is amplified by the luminance signal current amplifier circuit and outputted during a period other than the synchronization period, and a current corresponding to the synchronous signal is outputted during the synchronization period.

4. The video signal output circuit according to claim 3, which detects the synchronization period from the luminance signal in a sync separation circuit, and clamps the luminance signal in a pedestal clamp circuit by an output of the sync separation circuit, followed by removing the synchronous signal from the luminance signal.

5. The video signal output circuit according to claim 2, comprising a terminal detection circuit that measures a lowest potential at load and a lowest potential at no load from an output signal waveform of the video signal output terminal, sets a reference potential between the lowest potential at load and the lowest potential at no load, thereby detecting whether or not a load is connected to the video signal output terminal.

6. A semiconductor integrated circuit comprising the video signal output circuit according to claim 1.

7. The video signal output circuit according to claim 1, comprising a terminal detection circuit that measures a lowest potential at load and a lowest potential at no load from an output signal waveform of the video signal output terminal, sets a reference potential between the lowest potential at load and the lowest potential at no load, thereby detecting whether or not a load is connected to the video signal output terminal.

8. A semiconductor integrated circuit comprising the video signal output circuit according to claim 2.
